(19) United States
(12) Patent Application Publication
(10) Pub. No.: US 2020/0247295 A1
(43) Pub. Date: Aug. 6, 2020

(54) VEHICLE HEAD RESTRAINT INCORPORATING SPEAKERS

(71) Applicant: GM GLOBAL TECHNOLOGY OPERATIONS LLC, Detroit, MI (US)

(72) Inventor: Wayne F. Manista, Clawson (US)

(21) Appl. No.: 16/266,648

(22) Filed: Feb. 4, 2019

(51) Int. Cl. B60N 2/879

(52) U.S. Cl. CPC B60N 2/879; H04R 1/025

(57) ABSTRACT

A vehicle head restraint includes a speaker positioned directly behind a head of a vehicle passenger occupying a seat when the vehicle passenger head is substantially centered in front of the head restraint, a head restraint support defining an internal open cavity, and an acoustically transparent material supported by the head restraint support across a forward face of the internal open cavity. The acoustically transparent material restrains the rearward motion of the head of the vehicle passenger and the speaker is directed toward a center of the head restraint.

### FIELD

The present disclosure relates to a vehicle head restraint incorporating speakers.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Conventional vehicle head restraints may incorporate speakers which produce audio sound for vehicle seat passenger occupants. There is a continuing desire to provide a high-quality audio experience to those occupants. Many of the conventional vehicle head restraints incorporating speakers tend to position those speakers to the side of a head of an occupant in order to direct the audio generated by those speakers more directly at the ears of that occupant. However, in order to position those speakers in that manner, the size of the head restraint is greatly increased which can adversely affect the view and the aesthetics of the design.

### SUMMARY

In an exemplary aspect, a vehicle head restraint includes a speaker positioned directly behind a head of a vehicle passenger occupying a seat when the vehicle passenger head is substantially centered in front of the head restraint, a head restraint support defining an internal open cavity, and an acoustically transparent material supported by the head restraint support across a forward face of the internal open cavity. The acoustically transparent material restrains the rearward motion of the head of the vehicle passenger and the speaker is directed toward a center of the head restraint.

In this manner, a vehicle head restraint improves speaker performance while minimizing the size of the head restraint, improving visibility and maintaining performance of head restraint function.

In another exemplary aspect, the speaker is positioned toward one side of the head restraint.

In another exemplary aspect, the speaker is positioned toward an upper side of the head restraint.

In another exemplary aspect, the speaker is positioned toward a lower side of the head restraint.

In another exemplary aspect, the speaker is positioned toward a lateral side of the head restraint.

In another exemplary aspect, the acoustically transparent material is a 3D knit fabric.

In another exemplary aspect, the acoustically transparent material is a louvered surface.

In another exemplary aspect, the acoustically transparent material is a net.

In another exemplary aspect, the internal open cavity defined by the head restraint support forms a through-bore extending longitudinally through a central portion of the head restraint.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of a vehicle head restraint in accordance with an exemplary embodiment of the present disclosure;

FIG. 2 is a perspective view of another vehicle head restraint in accordance with an exemplary embodiment of the present disclosure;

FIG. 3 is a perspective view of another vehicle head restraint in accordance with an exemplary embodiment of the present disclosure;

FIG. 4 is a perspective view of another vehicle head restraint in accordance with an exemplary embodiment of the present disclosure; and

FIG. 5 is a perspective view of another vehicle head restraint in accordance with an exemplary embodiment of the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

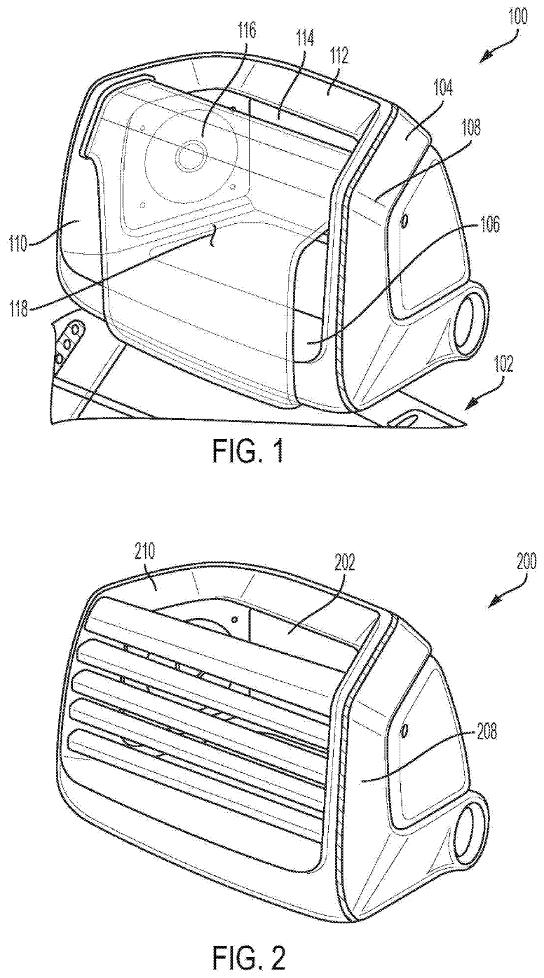

FIG. 1 is a perspective view of a vehicle head restraint 100 in accordance with an exemplary embodiment of the present disclosure. The head restraint 100 is connected to and supported by a seat back 102 of a vehicle passenger seat. The head restraint 100 includes a head restraint support structure 104 which includes a lower horizontally extending structure 106, a left side upright support 108, a right side upright support 110, and an upper, horizontally extending support 112 extending between upper ends of the left side upright support 108 and the right side upright support 110. The head restraint 100 defines an internal open cavity 114 that provides a through-bore extending longitudinally through a central-portion of the head restraint 100. The head restraint 100 further includes a speaker 116 positioned in the right side upright support 110 and directed toward the center of the head restraint 100. Preferably, the head restraint 100 may further include another speaker (not shown) positioned in the left side upright support 108 that is also directed toward the center of the head restraint 100. The head restraint 100 also includes an acoustically transparent material 118 that is connected to and thereby supported by the head restraint support structure 104. In this exemplary embodiment the acoustically transparent material 118 is a fabric that is connected to a lower forward portion of the lower horizontally extending structure 106, a forward-facing upper portion of the right side upright support 110, and a forward-facing upper portion of the left side upright support 108. In this manner, the head restraint 100 provides a high-quality audio experience because the speaker 116 directs its output into an internal cavity 114 and through the acoustically transparent material 118 more directly to the ears of a passenger occupying the vehicle seat, while minimizing the size of the head restraint 100 and providing the proper support and comfort to the head of an occupant.

FIG. 2 is a perspective view of another vehicle head restraint 200 in accordance with an exemplary embodiment of the present disclosure. The vehicle head restraint 200 is similar to the head restraint 100 illustrated in FIG. 1. However, rather than relying upon an acoustically transparent fabric 118 to provide support and comfort to the head of an occupant, the head restraint 200 includes a plurality of louvers or ribs 202 supported by and extending between forward facing edges of a left side upright support 208 and a right side upright support 210.

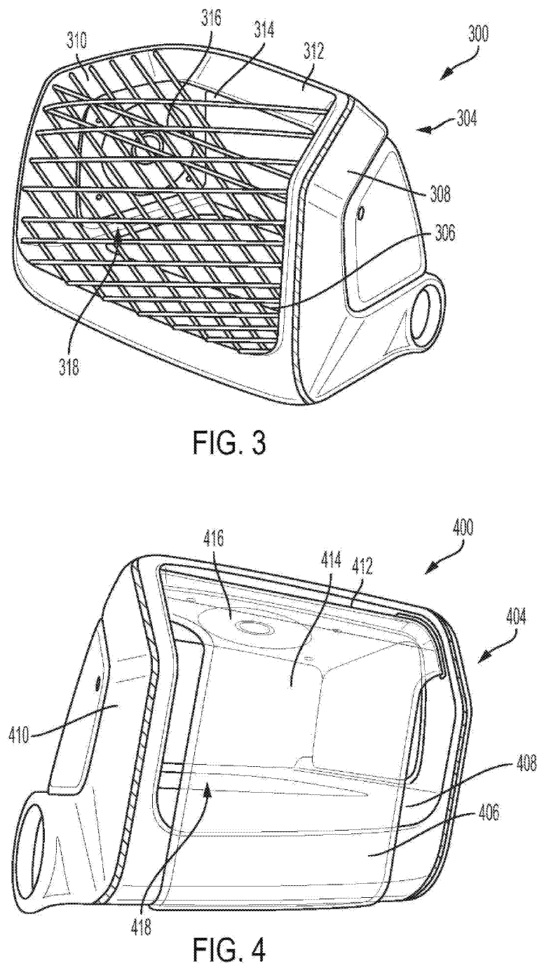

FIG. 3 is a perspective view of another vehicle head restraint 300 in accordance with an exemplary embodiment of the present disclosure. The head restraint 300 is connected to and supported by a seat back (not shown) of a vehicle passenger seat. The head restraint 300 includes a head restraint support structure 304 which includes a lower horizontally extending structure 306, a left side upright support 308, a right side upright support 310, and an upper, horizontally extending support 312 extending between upper ends of the left side upright support 308 and the right side upright support 310. The head restraint 300 defines an internal open cavity 314 that provides a through-bore extending longitudinally through a central-portion of the head restraint 300. The head restraint 300 further includes a speaker 316 positioned in the right side upright support 310 and directed toward the center of the head restraint 300. Preferably, the head restraint 300 may further include another speaker (not shown) positioned in the left side upright support 308 that is also directed toward the center of the head restraint 300. The head restraint 300 also includes an acoustically transparent material 318 that is connected to and thereby supported by the head restraint support structure 304. In this exemplary embodiment the acoustically transparent material 318 is a netting that is connected to a lower forward portion of the lower horizontally extending structure 306, a forward-facing portion of the right side upright support 310, and a forward-facing portion of the left side upright support 308. In this manner, the head restraint 300 provides a high-quality audio experience because the speaker 316 directs its output into an internal cavity 314 and through the acoustically transparent material 318 more directly to the ears of a passenger occupying the vehicle seat, while minimizing the size of the head restraint 300 and providing the proper support and comfort to the head of an occupant.

FIG. 4 is a perspective view of a vehicle head restraint 400 in accordance with an exemplary embodiment of the present disclosure. The head restraint 400 is connected to and supported by a seat back (not shown) of a vehicle passenger seat. The head restraint 400 includes a head restraint support structure 404 which includes a lower horizontally extending structure 406, a left side upright support 408, a right side upright support 410, and an upper, horizontally extending support 412 extending between upper ends of the left side upright support 408 and the right side upright support 410. The head restraint 400 defines an internal open cavity 414 that provides a through-bore extending longitudinally through a central-portion of the head restraint 400. The head restraint 400 further includes a speaker 416 positioned in the upper, horizontally extending support 412 and directed toward the center of the head restraint 400. The head restraint 400 also includes an acoustically transparent material 418 that is connected to and thereby supported by the head restraint support structure 404. In this exemplary embodiment the acoustically transparent material 418 is a fabric that is connected to a lower forward portion of the lower horizontally extending structure 406, a forward-facing portion of the right side upright support 410, a forward facing portion of the left side upright support 108, and a forward facing portion of the upper, horizontally extending support 412. In this manner, the head restraint 400 provides a high-quality audio experience because the speaker 416 directs its output into an internal cavity 414 and through the acoustically transparent material 418 more directly to the ears of a passenger occupying the vehicle seat, while minimizing the size of the head restraint 400 and providing the proper support and comfort to the head of an occupant.

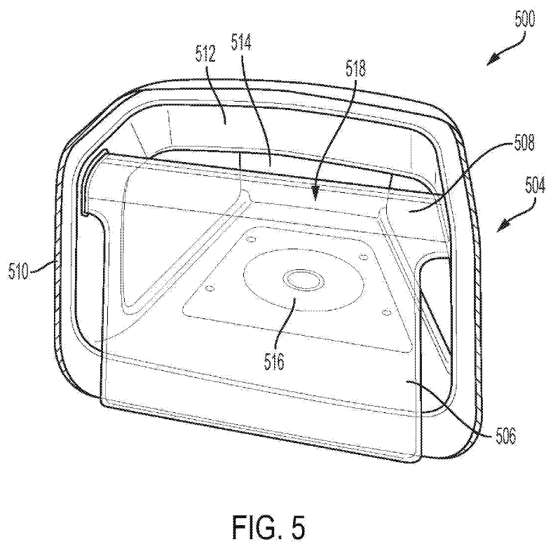

FIG. 5 is a perspective view of a vehicle head restraint 500 in accordance with an exemplary embodiment of the present disclosure. The head restraint 500 is connected to and supported by a seat back (not shown) of a vehicle passenger seat. The head restraint 500 includes a head restraint support structure 504 which includes a lower horizontally extending structure 506, a left side upright support 508, a right side upright support 510, and an upper, horizontally extending support 512 extending between upper ends of the left side upright support 508 and the right side upright support 510. The head restraint 500 defines an internal open cavity 514 that provides a through-bore extending longitudinally through a central-portion of the head restraint 500. The head restraint 500 further includes a speaker 516 positioned in the lower horizontally extending structure 506 and directed toward the center of the head restraint 500. The head restraint 500 also includes an acoustically transparent material 518 that is connected to and thereby supported by the head restraint support structure 504. In this manner, the head restraint 500 provides a high-quality audio experience because the speaker 516 directs its output into an internal cavity 514 and through the acoustically transparent material 518 more directly to the ears of a passenger occupying the vehicle seat, while minimizing the size of the head restraint 500 and providing the proper support and comfort to the head of an occupant.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

1. A vehicle head restraint comprising:
a head restraint support defining an internal open cavity that is centrally positioned in the head restraint;
a speaker positioned in the head restraint that is directed toward a center of the head restraint; and
an acoustically transparent material supported by the head restraint support across a forward face of the internal open cavity.

2. The vehicle head restraint of claim 1, wherein the speaker is positioned toward one side of the head restraint.

3. The vehicle head restraint of claim 2, wherein the speaker is positioned toward an upper side of the head restraint.

4. The vehicle head restraint of claim 2, wherein the speaker is positioned toward a lower side of the head restraint.

5. The vehicle head restraint of claim 2, wherein the speaker is positioned toward a lateral side of the head restraint.

6. The vehicle head restraint of claim 1, wherein the acoustically transparent material comprises a 3D knit fabric.

7. The vehicle head restraint of claim 1, wherein the acoustically transparent material comprises a louvered surface.

8. The vehicle head restraint of claim 1, wherein the acoustically transparent material comprises a net.

9. The vehicle head restraint of claim 1, wherein the internal open cavity defined by the head restraint support forms a through-bore extending longitudinally through a central portion of the head restraint.

10. A vehicle seat with a vehicle head restraint comprising:
an upwardly extending seat back;
a head restraint support in a head restraint mounted to the upwardly extending seat back and defining an internal open cavity that is centrally positioned in the head restraint;
a speaker positioned in the head restraint that is directed toward a center of the head restraint; and
an acoustically transparent material supported by the head restraint support across a forward face of the internal open cavity.

11. The vehicle seat of claim 10, wherein the speaker is positioned toward one side of the head restraint.

12. The vehicle seat of claim 11, wherein the speaker is positioned toward an upper side of the head restraint.

13. The vehicle seat of claim 11, wherein the speaker is positioned toward a lower side of the head restraint.

14. The vehicle seat of claim 11, wherein the speaker is positioned toward a lateral side of the head restraint.

15. The vehicle seat of claim 10, wherein the acoustically transparent material comprises a 3D knit fabric.

16. The vehicle seat of claim 10, wherein the acoustically transparent material comprises a louvered surface.

17. The vehicle seat of claim 10, wherein the acoustically transparent material comprises a net.

18. The vehicle head restraint of claim 10, wherein the internal open cavity defined by the head restraint support forms a through-bore extending longitudinally through a central portion of the head restraint.
